(19) United States
(12) Patent Application Publication
(10) Pub. No.: US 2020/0272965 A1
(43) Pub. Date: Aug. 27, 2020

(54) VEHICLE SHARE RIDE SUPPORT SYSTEM

(71) Applicant: HONDA MOTOR CO., LTD., Tokyo (JP)

(72) Inventors: Hiroyuki Tanabe, Wako-shi (JP); Koji Aoki, Wako-shi (JP)

(21) Appl. No.: 16/703,317

(22) Filed: Dec. 4, 2019

(30) Foreign Application Priority Data
Feb. 22, 2019 (JP) 2019-030768

(51) Int. Cl. G06Q 10/06; G07B 15/02

(52) U.S. Cl. CPC G06Q 10/06311; G06Q 2240/00; G07B 15/02

(57) ABSTRACT

The vehicle share ride support system is configured to acquire a moving schedule of the user, indicating the destination, the boarding operating vehicle, and the alighting departure/arrival place, estimate the arrival time of the user at the departure/arrival place from the operation information of the operating vehicle, and generate and output the user group information indicating a user group by the destination, which includes the users who arrive at the departure/arrival place within the predetermined period including the arrival time.

### INCORPORATION BY REFERENCE

The present application claims priority under 35 U.S.C. § 119 to Japanese Patent Application No. 2019-030768 filed on Feb. 22, 2019. The content of the applications is incorporated herein by reference in its entirety.

### BACKGROUND OF THE INVENTION

### Field of the Invention

The present invention relates to a vehicle share ride support system that supports efficient matching between a plurality of users intending to move to the destination by using a ride sharable vehicle (share ride vehicle) and the share ride vehicle.

### Description of the Related Art

There has been a known automobile share ride support method for matching between a driver of a vehicle and prospective users of the vehicle based on planned moving information of the vehicle and the driver, and planned traveling information of the prospective users (time, boarding place, destination and the like) to notify the driver and the prospective users of the appointment place and appointment time (see Japanese Patent Laid-Open No. 2002-140399).

The vehicle share ride system is available for the share ride vehicle to be used by those who commute to their office or school on a daily basis. With the generally employed automobile share ride support method, each prospective user supplies the planned moving information including the place and the time desired to board the share ride vehicle so that the matching is executed between the share ride vehicle and the prospective user based on the supplied planned moving information.

Generally, matching is executed between the single share ride vehicle and the prospective users who have supplied the similar information of the desired boarding place and the desired boarding time as share ride passengers. As a result, a spare time is added for securing the departure time of the share ride vehicle, resulting in deteriorated convenience of the users. Meanwhile, aiming at improved convenience for users by reducing the spare time, the number of candidates of the users to be matched will be reduced, resulting in no matching between the share ride vehicle and the prospective users, or deteriorated utilization efficiency of the system owing to few passengers of the share ride vehicle.

There may be the case that the train for commuting to the office or school is behind the schedule. The prospective user who encounters the train delay is required to re-input the desired boarding time on each occasion of the train delay. If the user expected to be late in arriving at the desired boarding place owing to the train delay fails to re-input the desired boarding time, other users who have planned to board the same share ride vehicle have to wait for a length of time until the user behind the schedule arrives, causing transportation difficulties.

The known share ride reservation management method has been disclosed in Japanese Patent Laid-Open No. 2005-18697 for a plurality of tourists who are expected to gather at the fixed place from the remote place by taking public transportation. In the reservation management method, the mediation device acquires the reserved seat of the public transportation based on the required condition of the user, and acquires the arrival time of the public transportation having the seat reserved at the gathering place from the operation management device of the public transportation. The user is then notified of the list of available share ride vehicles, which has been prepared based on the arrival time.

Normally, however, the seat reservation of the commuting vehicle of public transportation on the daily basis is a rare case. Therefore, it is difficult to execute the efficient matching between the share ride vehicle and the prospective users with the generally employed reservation management method.

### SUMMARY OF THE INVENTION

It is an object of the present invention to improve convenience of the user of the share ride vehicle by reducing the waiting time for transfer to the share ride vehicle after alighting from the public transportation without involving boarding reservation of the public transportation.

An aspect of the present invention is a vehicle share ride support system which includes a user information acquisition section that acquires user moving information on an operating vehicle of a public transportation to be used by a user, a planned alighting departure/arrival place, and a destination of the user, an operation information acquisition section that acquires operation information on an arrival time of the operating vehicle at the planned alighting departure/arrival place, an arrival time estimation section that estimates the arrival time of the user at the planned alighting departure/arrival place based on the user moving information and the operation information, and a grouping section that generates and outputs, based on the user moving information and the estimated arrival time, user group information indicating a user group by the destination, including the users who are assumed to arrive at the planned alighting departure/arrival place within a predetermined time period including the estimated arrival time.

In another aspect of the present invention, the user information acquisition section acquires a current location of the user from a mobile terminal of the user, and estimates the operating vehicle to be used by the user based on the acquired current location.

In another aspect of the present invention, the user information acquisition section acquires commuting route information of the user, and estimates the operating vehicle to be used by the user, the planned alighting departure/arrival place, and/or the destination based on the commuting route information.

In another aspect of the present invention, the grouping section generates and outputs the user group information of the group of the users who arrive at the planned alighting departure/arrival place by using the operating vehicle.

In another aspect of the present invention, the operation information contains delay information of the operating vehicle. The arrival time estimation section acquires the delay information from a server managed in the public transportation or a mobile terminal of an information provider.

In another aspect of the present invention, the arrival time estimation section re-estimates the arrival time when the operation information has been changed. When the arrival time is re-estimated, the grouping section re-generates and outputs the user group information based on the re-estimated arrival time.

Another aspect of the present invention further includes a vehicle information acquisition section that acquires vehicle information on the vehicle available for share ride with the users, and a vehicle allocation section that allocates the available vehicle to the user group indicated by the user group information based on the vehicle information.

In another aspect of the present invention, the vehicle allocation section updates the vehicle allocation when the user group information is re-generated.

In another aspect of the present invention, the vehicle corresponds to a shared vehicle to be shared with the users, a share ride vehicle intended to be permitted for share ride by an owner of the vehicle, or a taxi that allows a preliminarily assigned driver to transport the user upon request.

In another aspect of the present invention, the public transportation includes a railroad, a bus, or an airplane.

### Advantageous Effect of Invention

According to the aspect of the present invention, convenience of the user of the share ride vehicle may be improved by reducing the waiting time for transfer to the share ride vehicle after alighting from the public transportation without involving boarding reservation of the public transportation.

### BRIEF DESCRIPTION OF DRAWINGS

FIG. 1 is an explanatory view of an exemplary operation of a vehicle share ride support system according to an embodiment of the present invention;

FIG. 2 is a diagram of an exemplary configuration of the vehicle share ride support system according to the present invention;

FIG. 3 illustrates an example of a screen for inputting user moving information of a mobile terminal that transmits the user moving information to the vehicle share ride support system; and

FIG. 4 is a flowchart of process steps for operating the vehicle share ride support system according to the present invention.

### DETAILED DESCRIPTION OF THE PREFERRED EMBODIMENT

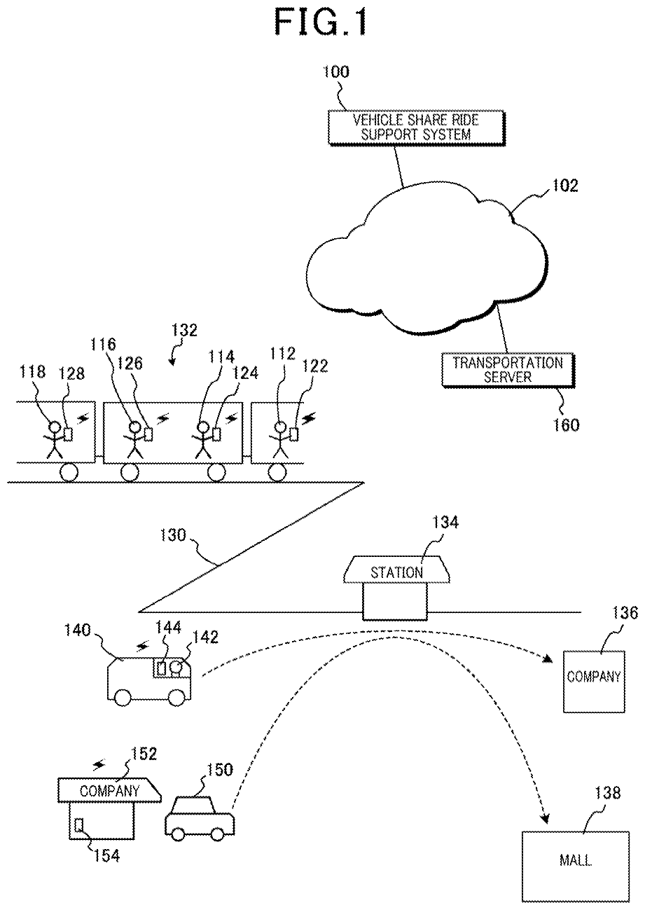

An embodiment of the present invention will be described referring to the drawings. FIG. 1 is an explanatory view of an exemplary operation of a vehicle share ride support system 100 according to an embodiment of the present invention. The vehicle share ride support system 100 according to the embodiment is configured by a single apparatus, for example, a server. The above configuration is a mere example, and accordingly, the vehicle share ride support system 100 may be configured by a plurality of mutually communicably connected devices.

The vehicle share ride support system 100 is communicably connected to mobile terminals 122, 124, 126, 128 of the users 112, 114, 116, 118 who desire the use of the share ride vehicle indirectly with a network 102 such as the internet, or directly with no network 102. Those users 112, 114, 116, 118 are planning to board a train 132 operated on a railroad line 130 as the public transportation, and to alight at a departure/arrival place 134 as a station of the line 130. The users 112, 114, 116, 118 desire the use of the share ride vehicle after alighting from the train at the departure/arrival place 134. The users 112, 114 are planning to go to a destination 136, for example, a company, and the users 116, 118 are planning to go to a destination 138, for example, a mall.

The vehicle share ride support system 100 is also communicably connected to a mobile terminal 144 of a provider 142 intending to provide a vehicle 140 owned thereby as the share ride vehicle, and to a terminal device 154 of a taxi company 152 that owns a taxi 150 indirectly with a network 102 or directly with no network 102 for example. The vehicle 140 may be used as the shared vehicle for a plurality of users, or as the share ride vehicle permitted by its owner for share ride.

The vehicle share ride support system 100 acquires vehicle information on the vehicle (vehicle 140, taxi 150, and the like) available as the share ride vehicle from the mobile terminal 144 of the provider 142 and/or the terminal device 154 of the taxi company 152. The vehicle information contains the information for identifying at least the vehicle to be used (for example, model, color, registered number of number plate).

The vehicle share ride support system 100 is communicably connected to a server operated by the railroad company that manages the railroad of the line 130, for example, a transportation server 160 as a railroad operation management server for managing the railroad operation via the network 102.

The above-described vehicle share ride support system 100 acquires user moving information of the user 112 and the like. The user moving information contains the information on the operating vehicle of public transportation (boarding operating vehicle) used by each of the user 112 and the like, the departure/arrival place where the user is planning to alight (planned alighting place), and the destination of the user 112 and the like. Referring to the example as shown in FIG. 1, the boarding operating vehicle of the user 112 and the like is the train 132 to be operated on the line 130. The planned alighting place is the departure/arrival place 134 as a station of the line 130. The destination 136 of the users 112, 114 is the company, and the destination 138 of the users 116, 118 is the mall, for example.

Before or under boarding of the train 132, the user 112 and the like transmit their user moving information to the vehicle share ride support system 100 via the mobile terminal 122 and the like.

The vehicle share ride support system 100 acquires operation information on the arrival time of the train 132 as the operating vehicle of public transportation at the departure/arrival place 134 from the transportation server 160, for example. Specifically, the operation information may contain delay information of the train 132 as the boarding operating vehicle of the user 112 and the like behind the operation schedule. The “delay information behind the operation schedule” may represent the estimated delay time behind the planned arrival time (for example, the arrival time on the timetable supplied from the railroad company) as expressed by the operation plan bound for the planned alighting place, or the information of the estimated delay time. The operation information may be acquired from the mobile terminal of an arbitrary information provider including the user 112 and the like besides the transportation server 160.

The vehicle share ride support system 100 estimates the arrival time of the user 112 and the like at the departure/arrival place 134 as the planned alighting place based on the acquired user moving information and the operation information of the user 112 and the like.

The vehicle share ride support system 100 generates user group information indicating a user group by the destination, including the user 112 and the like who are estimated to arrive at the departure/arrival place 134 as the planned alighting place within a predetermined time period including the estimated arrival time, based on the user moving information and the estimated arrival time. The user for generation of the user group information may be the user 112 and the like who board the same operating vehicle, that is, the same train 132 to arrive at the departure/arrival place 134. It is also possible to include the other user who desires to board the share ride vehicle at the departure/arrival place 134 in the predetermined time period.

The vehicle share ride support system 100 may be applied to another kind of public transportation that leaves and stops at the same place as the departure/arrival place 134 on the line 130, for example, the bus as the operating vehicle. Likewise the operating vehicle as described above, the user moving information of the user planning to use the bus and the bus operation information will be acquired to estimate the arrival time of the bus at the departure/arrival place. If the estimated arrival time is within the predetermined time period, the user planning to use the bus may be contained for generation of the user group information.

Alternatively, the vehicle share ride support system 100 may be configured to acquire the planned moving information of the user who does not use the public transportation in accordance with the generally employed process, and generate the user group information that contains the user who desires boarding of the share ride vehicle at the departure/arrival place 134 within the predetermined time period.

Based on the vehicle information acquired from the mobile terminal 144 and the like, the vehicle share ride support system 100 allocates the available share ride vehicle to the user group indicated by the user group information. The vehicle share ride support system 100 generates vehicle allocation information having each of the user groups associated with the information on the allocated share ride vehicle (for example, vehicle identification information).

The vehicle share ride support system 100 transmits the generated user group information and the vehicle allocation information to the mobile terminal 122 of the user 112 and the like, the mobile terminal 144 of the provider 142 of the vehicle 140 as the share ride vehicle, and the terminal device 154 of the taxi company 152, and outputs the information.

The provider 142 and/or the taxi company 152 may operate the vehicle 140 and/or the taxi 150 bound for the departure/arrival place at the end time of the predetermined time period to allow the user 112 and the like accessing to the same destination 136 to board the vehicle and/or the taxi in accordance with the user group information.

The above-configured vehicle share ride support system 100 estimates the arrival time of the user 112 and the like at the departure/arrival place 134 as the planned alighting place based on the user moving information and the operation information, and sorts the users assumed to arrive at the departure/arrival place 134 within the predetermined time period including the estimated arrival time into the user groups by the destination. The share ride vehicle allocated to the corresponding user group does not have to wait for the user behind the schedule owing to the train delay or the like. The vehicle share ride support system 100 allows improvement of the user's convenience by reducing the waiting time for transfer to the share ride vehicle after alighting from the public transportation without involving boarding reservation of the public transportation.

Even if the train 132 is delayed, the vehicle share ride support system 100 may be configured to acquire an extent of the delay from the operation information, and generate the user group information by correcting the estimated arrival time at the departure/arrival place 134. The user 112 and the like do not have to be involved with troublesome process for correcting the user moving information once transmitted in accordance with the delay, and re-transmitting the corrected information.

In the example of FIG. 1, the public transportation is the railroad. However, the public transportation is not limited to the railroad but may be the above-described bus and airplane. The operating vehicle may be used by the user 112 and the like with or without involvement of boarding reservation. In the case of the operating vehicle that allows the boarding reservation, the use of the vehicle share ride support system 100 may improve the user's convenience by reducing the waiting time for transfer to the share ride vehicle after alighting from the public transportation with no boarding reservation of the operating vehicle.

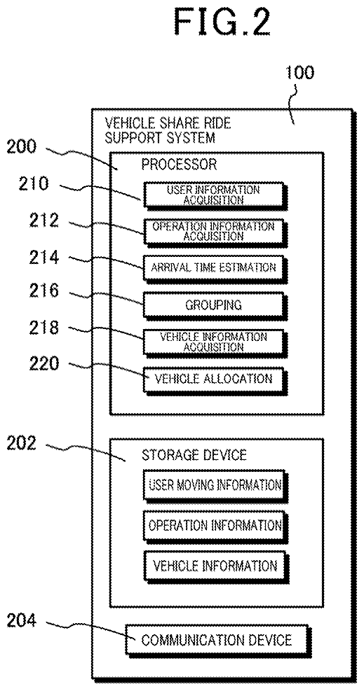

The configuration of the vehicle share ride support system 100 will be described. FIG. 2 is a diagram of an exemplary configuration of the vehicle share ride support system 100. The vehicle share ride support system 100 includes a processor 200, a storage device 202, and a communication device 204. The storage device 202 constituted by, for example, a volatile semiconductor memory, a non-volatile semiconductor memory, and/or a hard disk device stores data and/or program required for operating the processor 200.

The communication device 204 is a transmitter-receiver for wired or wireless communication. The communication device 204 communicably connects the processor 200 to the mobile terminals 122, 124, 126, 128 of the users 112, 114, 116, 118, the mobile terminal 144 of the provider 142, and the terminal device 154 of the taxi company 152 indirectly with the network 102 or directly with no network 102. The communication device 204 communicably connects the processor 200 to the transportation server 160 via the network 102.

The processor 200 is a computer that installs such processor as a CPU (Central Processing Unit), for example. The processor 200 may be constituted to have a ROM (Read Only Memory) into which the program is written, a RAM (Random Access Memory) for temporarily storing data, and the like. The processor 200 has function elements or function units including a user information acquisition section 210, an operation information acquisition section 212, an arrival time estimation section 214, a grouping section 216, a vehicle information acquisition section 218, and a vehicle allocation section 220.

For example, those function elements of the processor 200 are implemented by the program executed by the processor 200 as the computer. The computer program may be stored in the arbitrary computer readable storage medium. Alternatively, the function elements of the processor 200 may be entirely or partially constituted by hardware including one or more electronic circuit component.

The user information acquisition section 210 acquires the user moving information on the operating vehicle (boarding operating vehicle) of public transportation to be used by the user, the departure/arrival place where the user is planning to alight (planned alighting place), and the user's destination. The acquired information is stored in the storage device 202. Besides the information as described above, the user moving information may contain identification information of the user as the transmission source (from where the information is acquired) of the user moving information (for example, the user name, the identification number preliminarily imparted to the user, or the communication address or phone number of the mobile terminal of the user).

In the example of FIG. 1, the user information acquisition section 210 acquires the user moving information from the mobile terminal 122 of the user 112 and the like, for example, indicating that the boarding operating vehicle of the user 112 and the like is the train 132, the planned alighting place is the departure/arrival place 134, and the destinations of the users 112 and the like are the destinations 136, 138. The “train 132 as the boarding operating vehicle” may be indicated by the planned arrival time at the departure/arrival place as the planned alighting place. However, this is just one example, and alternatively, “the train 132 as the boarding operating vehicle” may be indicated by the identification number preliminarily imparted to the train 132 by the railroad company and the like.

Each of the user 112 and the like transmits the user moving information of its own to the vehicle share ride support system 100 via the corresponding mobile terminal 122 and the like before or under boarding of the train 132. The user information acquisition section 210 receives the transmitted user moving information for acquirement.

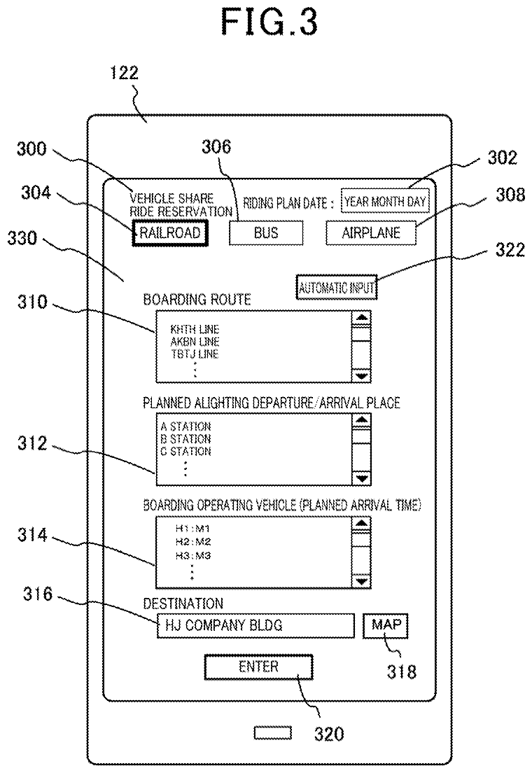

The user 112 and the like executes the dedicated application program installed in the mobile terminal 122 and the like to input the user moving information, and transmit the information to the vehicle share ride support system 100. FIG. 3 shows an input screen of the mobile terminal 122 and the like as the smartphone on which the user moving information is displayed by executing the dedicated application program. Referring to FIG. 3, the mobile terminal 122 of the user 112 is shown as the mobile terminal that displays the screen. However, the similar screen is displayed on the mobile terminal 124 of the other user 114 so that the user moving information of the user 114 is transmitted by the similar operation to the mobile terminal 122 to be described below.

In an example as shown in FIG. 3, a title 300 “vehicle share ride reservation” is displayed on the upper section of a screen 330 of the mobile terminal 122 of the user 112. The screen 330 displays a date input box 302, and three transportation selection buttons 304, 306, 308 for inputting the public transportation to be used by the user 112. The vehicle share ride date desired by the user 112 is input in the date input box 302.

Each of the transportation selection buttons 304, 306, 308 corresponds to “railroad”, “bus”, and “airplane”, respectively. Tapping one of the displayed buttons allows input of the corresponding public transportation either “railroad”, “bus”, or “airplane” to be used by the user 112.

In the example as shown in FIG. 3, the transportation selection button 304 that displays “railroad” is tapped to input the “railroad” as public transportation to be used by the user 112. Referring to the display shown in FIG. 3, the thus selected transportation selection button 304 of the “railroad” is expressed with thick line.

In the example as shown in FIG. 3, in response to selection of public transportation to the railroad by tapping the transportation selection button 304, the following lists are displayed on a lower section of the screen 330 below the transportation selection button 304 and the like. Specifically, a boarding route list 310, a planned alighting place list 312, and a boarding operating vehicle list 314 are displayed for inputting the boarding route, the planned alighting place, and the boarding operating vehicle of the railroad to be used by the user 112, respectively. The boarding operating vehicle list 314 displays the planned arrival time of the boarding operating vehicle at the departure/arrival place selected from the planned alighting place list 312, that is, the arrival time on the timetable.

The above-described lists are of drop-down type. The user 112 is allowed to touch an arbitrary line on the corresponding list so that the route, the departure/arrival place, and the operating vehicle corresponding to the touched lines are input as the route, the planned alighting place, and the boarding operating vehicle to be used by the user 112.

The screen 330 of the mobile terminal 122 further displays a destination input box 316 for inputting the destination of the user 112, and a map display button 318 as displayed “MAP” for supporting an input operation of the destination into the destination input box 316. The user 112 inputs the destination by inputting the address of the destination or the landmark name into the destination input box 316. Alternatively, the user 112 taps a map display button 318 to display the map (not shown) on the screen 330, and instructs the application program to input the name or the address of the touched place as the destination on the map into the destination input box 316.

After completion of inputting the date into the date input box 302, selection of the transportation selection button 304, and inputting the respectively selected information into the boarding route list 310, the planned alighting place list 312, and the boarding operating vehicle list 314 and the destination input box 316, the user 112 taps an enter button 320 displayed at the lower section of the screen. The data that have been input and selected may be transmitted as the user moving information to the vehicle share ride support system 100.

Alternatively, for example, the user 112 taps an automatic input button 322 displayed as “automatic input” on the screen 330 of the mobile terminal 122 to allow the application program installed in the mobile terminal 122 to estimate the current boarding route and the boarding operating vehicle. The application program is capable of estimating the route and the operating vehicle currently used by the user 112 based on the current time, the railroad route chart, each timetable of the scheduled operating vehicles on the respective routes, and the current location of the mobile terminal 122 acquired by GPS function installed therein. The mobile terminal 122 may be constituted to acquire the route chart and the timetable from, for example, the transportation server 160.

The application program notifies the user 112 of the estimated route and the estimated operating vehicle by inversely displaying the corresponding lines of the boarding route list 310 and the boarding operating vehicle list 314. The application program is capable of identifying the estimated operating vehicle as the identification number preliminarily imparted to the operating vehicle. The application program may inversely display the major station at which the estimated operating vehicle arrives subsequently in the planned alighting place list, and further inversely display the planned arrival time at the major station in the boarding operating vehicle list 314 for notification to the user 112. For example, the major station may be predetermined by the application program.

Alternatively, the application program may be constituted to estimate the planned alighting departure/arrival place and the destination of the currently moving user 112, and to further display the estimated information on the planned alighting place list 312 and the destination input box 316 based on information about the movement history of the mobile terminal 122 stored therein (transitional data of the current location stored at predetermined time intervals), and the daily movement route such as the commuting route preliminarily input to the mobile terminal 122 by the user 112.

If no error is found in the displayed information that has been estimated by the application program such as the boarding route, the planned alighting place, the boarding operating vehicle, and the destination, the user 112 simply taps the enter button 320. If an error is found, the user corrects the error, and taps the enter button 320 so that the user moving information is transmitted to the vehicle share ride support system 100.

In the example as described above, the application program of the mobile terminal 122 performs the function of estimating the boarding route, the planned alighting place, the boarding operating vehicle, and/or the destination. However, it is not limited to the one as described above. Instead of or in addition to the above-described function, the estimating function may be provided in the vehicle share ride support system 100. For example, the mobile terminal 122 may be constituted to transmit the current location information acquired by the GPS of the mobile terminal 122, and a movement estimation request signal to the vehicle share ride support system 100 in response to tapping of the automatic input button 322. The user information acquisition section 210 of the vehicle share ride support system 100 may be constituted to estimate the boarding route and the boarding operating vehicle of the user 112 at present in accordance with reception of the movement estimation request signal, and to transmit the estimated information to the mobile terminal 122.

In this case, the mobile terminal 122 may be constituted to inversely display the estimated boarding route and the estimated boarding operating vehicle, which have been received from the vehicle share ride support system 100 on the boarding route list 310 and the boarding operating vehicle list 314 of the screen 330 for informing the user 112. If the estimated boarding route and the estimated boarding operating vehicle as displayed on the screen 330 are correct, they can be used by the user 112. If they are incorrect, they may be corrected by the user 112. The user 112 further inputs the planned alighting place and the destination on the screen 330, and then taps the enter button 320 for transmitting the user moving information to the vehicle share ride support system 100.

The vehicle share ride support system 100 may be configured to acquire the information on daily moving route of the user 112, for example, the commuting route (commuting route information), based on which the boarding route, the boarding operating vehicle, the planned alighting place, and/or the destination are estimated. The information on the daily moving route such as the commuting route information may be acquired from the mobile terminal 122 when the vehicle share ride support system 100 receives the movement estimation request signal. The mobile terminal 122 may be constituted to transmit the daily moving route information to the vehicle share ride support system 100 together with the movement estimation request signal or upon reception of the request signal from the vehicle share ride support system 100.

The vehicle share ride support system 100 may be configured to preliminarily acquire the information on the daily moving route such as the commuting route information from the mobile terminal 122, and to propose registration of the user moving information (that is, transmission to the vehicle share ride support system 100) to the user 112. Specifically, based on the preliminarily acquired commuting route information, the vehicle share ride support system 100 estimates the boarding route, the boarding operating vehicle, the planned alighting place, and/or the destination of the user 112 before the commuting time, and transmits the estimated data to the mobile terminal 122. The registration of the user moving information containing those data may be proposed. Likewise, the mobile terminal 122 may be constituted to display those estimated data of boarding route, planned alighting place, boarding operating vehicle and/or destination on the boarding route list 310, the planned alighting place list 312, the boarding operating vehicle list 314, and the destination input box 316, respectively.

When the user 112 does not desire the vehicle share ride, the application may be terminated by ignoring the displayed information. In the case of correct information of the estimated planned alighting place and the like, the user 112 who desires the vehicle share ride taps the enter button. In the case of incorrect information, the user corrects the information, and taps the enter button 320. Finally, the user moving information may be transmitted to the vehicle share ride support system 100.

In the explanation referring to FIG. 3, the user taps the transportation selection button 304 indicating the train. When tapping the other transportation selection button 306 or 308, the similar process as described above is executed to allow the mobile terminal 122 to acquire the user moving information input by the user 112, and transmit the acquired information to the vehicle share ride support system 100.

In this case, when the user taps the transportation selection button 306 indicating that the bus is selected as the public transportation, the bus route list is displayed on the boarding route list 310, the bus stop list of the bus route selected from the boarding route list 310 is displayed on the planned alighting place list 312, and the planned arrival time list of the respective operating bus to the bus stop selected from the planned alighting place list 312 is displayed on the boarding operating vehicle list 314, respectively.

When the user taps the transportation selection button 308 indicating that airplane is selected as the public transportation, the flight route list is displayed on the boarding route list 310, the list of arrival airports of the flight selected from the boarding route list 310 is displayed on the planned alighting place list 312, and a list of the respective flights to the arrival airport selected from the planned alighting place list 312 is displayed on the boarding operating vehicle list 314, respectively. In this case, the boarding location to the share ride vehicle is preliminarily fixed at the corresponding airport. The arrival time or estimated arrival time of the user at the boarding location may be calculated as the time derived from adding the spare time to the arrival time or the estimated arrival time of the airplane at the airport.

Referring to FIG. 2, the operation information acquisition section 212 acquires the operation information on the arrival time of the boarding operating vehicle indicated by the user moving information at the planned alighting place indicated by the user moving information. In the example of FIG. 1, the operation information acquisition section 212 acquires the operation information on the arrival time of the train 132 as the boarding operating vehicle of the user 112 and the like at the departure/arrival place 134 as the planned alighting place. The operation information may be acquired from the server (the transportation server 160 in FIG. 1) managed by a proprietary company of the public transportation, or the mobile terminal of the arbitrary information provider. In this case, the mobile terminal of the information provider includes the mobile terminal 122 of the user 112 and the like who will use the boarding operating vehicle, for example.

The arrival time estimation section 214 estimates the arrival time of the user at the planned alighting place based on the user moving information acquired by the user information acquisition section 210, and the operation information acquired by the operation information acquisition section 212. In the example of FIG. 1, based on the user moving information acquired by the user information acquisition section 210 from the user 112 via the mobile terminal 122 and the like, and the operation information acquired by the operation information acquisition section 212 from the transportation server 160 and/or the mobile terminal 122 of the user 112 and the like, the arrival time estimation section 214 estimates the arrival time of the user 112 and the like at the departure/arrival place 134 as the planned alighting place.

When there is a change in the operation information, the arrival time estimation section 214 re-estimates the arrival time of the corresponding user at the planned alighting place. The “change in the operation information” represents the assumption that there is or has been the change in the current delay time of the boarding operating vehicle indicated by the currently acquired operation information from the previous delay time of the boarding operating vehicle indicated by the previously acquired operation information.

Based on the user moving information acquired by the user information acquisition section 210, and the arrival time (estimated arrival time) estimated by the arrival time estimation section 214, the grouping section 216 generates and outputs user group information representing the user group by the destination indicated by the user moving information of the respective users assumed to arrive at the planned alighting place within a predetermined time period including the estimated arrival time. In the example of FIG. 1, based on the user moving information acquired from the user 112 and the like, and the estimated arrival time of the user 112 and the like at the departure/arrival place 134 estimated by the arrival time estimation section 214, the grouping section 216 generates the user group information representing the user groups by the destinations 136, 138 of the users 112 and the like who are assumed to arrive at the departure/arrival place 134 within the predetermined time period including the estimated arrival time.

Specifically, the grouping section 216 extracts all the user moving information data containing the departure/arrival place 134 as the planned alighting place from the user moving information stored in the storage device 202 by the user information acquisition section 210. In the example of FIG. 1, the users 112, 114, 116, 118 set the same departure/arrival place 134 as the planned alighting place. The grouping section 216 then extracts all the user moving information data of the users 112, 114, 116, 118 from the user moving information stored in the storage device 202. The grouping section 216 groups the users 112, 114, 116, 118 each as the transmission source of the extracted user moving information into the user group by the destination indicated by the user moving information.

The user group information contains the list of the users belonging to the group at least sorted by the destination, who desire to move to the destination. More specifically, the user group information may contain the list of a group ID for identifying the user group, the destination, and identification information of the users belonging to the user group. The user identification information may contain the user's name, the ID number preliminarily imparted to the user, and/or the communication address or the phone number of the user's mobile terminal.

In the example as shown in FIG. 1, the user group information contains the information of a first user group intending to move to the destination 136, and the information of a second user group intending to move to the destination 138. The first user group information may contain, for example, a first group ID for identifying the user group, the information indicating that the intended destination is the destination 136, and the identification information list indicating the users 112 and 114 intending to move to the destination 136. The second user group information may contain a second group ID for identifying the user group, the information indicating that the intended destination is the destination 138, and the identification information list indicating the users 116 and 118 intending to move to the destination 138.

In the example as shown in FIG. 1, the grouping section 216 generates and outputs the user group information of the group of the users who use the same operating vehicle, that is, the same train 132 to arrive at the departure/arrival place 134. The above-described process is a mere example, and the grouping section 216 may be constituted to generate the user group information of the group of the users who use the other operating vehicle to arrive at the departure/arrival place within the predetermined time period including the arrival time (estimated arrival time) estimated by the arrival time estimation section 214.

Alternatively, the grouping section 216 may be constituted to set departure/arrival places of a plurality of public transportations in a predetermined correlation or in a predetermined distance range, for example, the train stations, the bus stops in front of the stations and the like to the single departure/arrival place. For example, the grouping section 216 may be constituted to generate the user group information of the users who use the operating vehicles of the multiple public transportations such as the train and the bus to arrive at the single departure/arrival place within the predetermined time period including the arrival time estimated by the arrival time estimation section 214.

When the arrival time estimation section 214 re-estimates the user's arrival time at the planned alighting place based on the changed operation information, the grouping section 216 re-generates and outputs the user group information based on the re-estimated arrival time.

The vehicle information acquisition section 218 acquires the vehicle information on the vehicle available for share ride with a plurality of users (that is, share ride vehicle). The vehicle available for share ride may be the shared vehicle to be shared with the users, the share ride vehicle permitted by the owner of the vehicle for share ride, or the taxi that allows the preliminarily assigned driver to transport the users in response to the request. The vehicle information may contain identification information (vehicle model, color, registered number of the number plate) for identifying the vehicle available for share ride, the location of the vehicle, the capacity, and/or the planned traveling route.

The vehicle information acquisition section 218 may be constituted to acquire the vehicle information from, for example, the server of the company for providing the shared vehicle, the mobile terminal of the provider of the share ride vehicle, the terminal device of the taxi company and the like. In the example of FIG. 1, the vehicle information acquisition section 218 may be constituted to acquire the location of the vehicle 140, capacity, information of the planned traveling route, and information of the location of the taxi 150 and capacity as the vehicle information from the mobile terminal 144 of the provider 142 as the owner of the vehicle 140 for share ride, and the terminal device 154 of the taxi company 152 as the owner of the taxi 150.

Based on the vehicle information acquired by the vehicle information acquisition section 218, the vehicle allocation section 220 allocates the vehicle available for share ride of the user group to those indicated by the user group information generated by the grouping section 216. The vehicle allocation section 220 transmits the vehicle allocation information derived from associating each of the user groups with the information on the allocated vehicle (for example, the vehicle identification information) to the mobile terminals of the users constituting the respective user groups.

In the example of FIG. 1, the vehicle allocation section 220 allocates the vehicle 140 and the taxi 150 each as the share ride vehicle to the user groups associated with the destinations 136, 138, respectively. The vehicle allocation section 220 generates first vehicle allocation information derived from association among the destination 136, the identification information of the vehicle 140, and identification information of the users 112, 114, and second vehicle allocation information derived from association among the destination 138, the identification information of the taxi 150, and identification information of the users 116, 118.

The vehicle allocation section 220 transmits the generated first vehicle allocation information to the mobile terminals 122, 124 of the users 112, 114 belonging to the user group associated with the destination 136. Likewise, the vehicle allocation section 220 transmits the generated second vehicle allocation information to the mobile terminals 126, 128 of the users 116, 118 belonging to the user group associated with the destination 138.

If the user group information is re-generated in the period between generation and transmission of the vehicle allocation information (that is, updated), the vehicle allocation section 220 re-allocates the vehicles for updating. For example, in response to the re-estimation of the arrival time by the arrival time estimation section 214 in accordance with change in the operation information, the vehicle allocation section 220 re-allocates the vehicles for updating the vehicle allocation information when the grouping section 216 re-generates the user group information for updating.

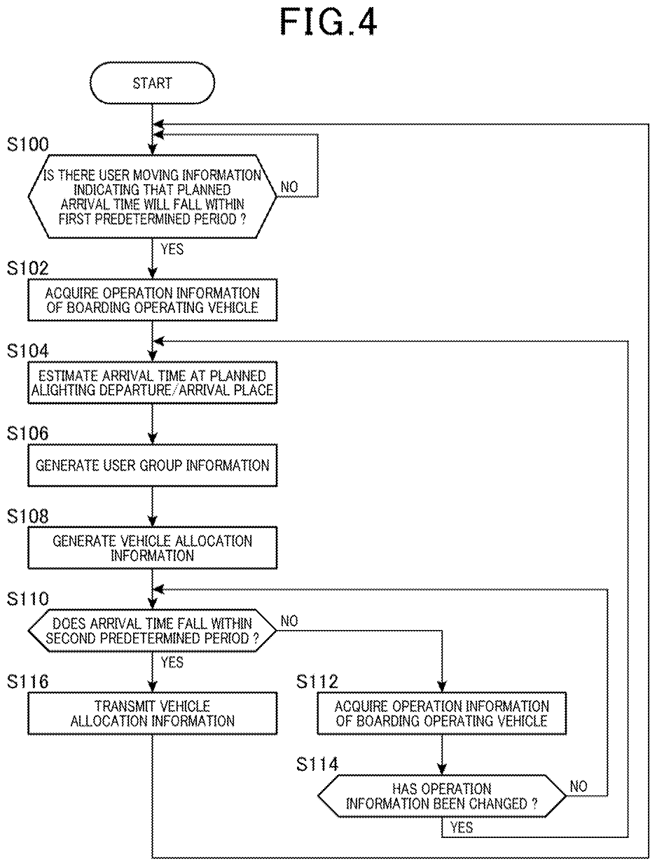

Operations of the vehicle share ride support system 100 will be described. FIG. 4 is a flowchart of process steps to be executed in the vehicle share ride support system 100. The processing as shown in FIG. 4 starts by turning the power source of the vehicle share ride support system 100 ON, and is terminated by turning the power source OFF. The user information acquisition section 210 of the vehicle share ride support system 100 is constituted to store the user moving information received from the mobile terminal 122 of the user 112 and the like into the storage device 202 in parallel with the processing as shown in FIG. 4. The vehicle information acquisition section 218 of the vehicle share ride support system 100 is constituted to store the vehicle information of the vehicle available as the share ride vehicle from the mobile terminal 144 of the provider 142 of the share ride vehicle, the terminal device 154 of the taxi company 152 and the like into the storage device 202 in parallel with the processing as shown in FIG. 4.

Upon start of the processing as shown in FIG. 4, the processor 200 of the vehicle share ride support system 100 determines whether or not the user moving information stored in the storage device 202 contains user moving information indicating that the planned arrival time will fall within a first predetermined period from the current time (S100). It is possible to set the first predetermined period as the period derived from adding the spare time to the time required to prepare or allocate the share ride vehicle at the planned alighting place indicated by the user moving information (for example, 1.5 hours). If there is no user moving information indicating that the planned arrival time will fall within the first predetermined period from the current time (S100, NO), the processor 200 returns to step S100, and waits until the current time precedes the first predetermined period from the planned arrival time indicated by the arbitrary user moving information.

Meanwhile, if there is the user moving information indicating that the planned arrival time will fall within the first predetermined period from the current time (S100, YES), the processor 200 allows the operation information acquisition section 212 to acquire the operation information on the boarding operating vehicle indicated by the user moving information to be processed, and stores the acquired information into the storage device 202 (S102). Based on the acquired operation information, the arrival time estimation section 214 estimates the arrival time of the boarding operating vehicle indicated by the user moving information to be processed at the planned alighting place as indicated by the user moving information (S104).

The grouping section 216 generates the user group information of the users of the group by the destination, who are assumed to arrive at the planned alighting place within the predetermined time period including the estimated arrival time (S106).

The vehicle allocation section 220 generates the vehicle allocation information based on the user group information, and the vehicle information stored in the storage device 202 (S108).

The grouping section 216 determines whether or not the estimated arrival time will fall within a second predetermined period from the current time (S110). The second predetermined period may be set to be equal to or shorter than the first predetermined period (for example, 1 hour).

If the estimated arrival time does not fall within the second predetermined period from the current time (S106, NO), the operation information acquisition section 212 re-acquires the operation information on the boarding operating vehicle indicated by the user moving information to be processed (S112). In step S102, it is determined whether or not the acquired operation information has been changed from the one stored in the storage device 202 (S114). If it has been changed (S114, YES), the operation information acquisition section 212 rewrites the operation information stored in the storage device 202 in step S102 with the operation information acquired in step S108 for updating. The process then returns to S104 for executing the processing repeatedly.

In step S112, if the operation information re-acquired in step S112 has not been changed from the one stored in the storage device 202 in step S102 (S114, NO), the processor 200 returns to step S110 for executing the processing repeatedly.

Meanwhile, in step S110, if the arrival time estimated in step S104 will fall within the second predetermined period from the current time (S106, YES), the vehicle allocation section 220 transmits the generated vehicle allocation information to the terminal device of the provider of the allocated vehicle, and the mobile terminal 122 of the user 112 and the like as members of the user group allocated to the vehicle for notification (S116).

Subsequent to step S116 in which the vehicle allocation section 220 has transmitted the vehicle allocation information, the processor 200 returns to step S100 for executing the processing repeatedly.

The present invention is not limited to the structure of the above-described embodiment, but may be variously implemented within the range of the scope of the invention.

For example, the vehicle share ride support system 100 of the embodiment is configured as the single apparatus such as the single server connected to the network 102. However, the configuration is not limited to the one as described above. The vehicle share ride support system 100 may be constituted by a plurality of devices corresponding to the divided functions. For example, the vehicle share ride support system 100 may be configured by a first apparatus having functions including the vehicle information acquisition section 218 and the vehicle allocation section 220, and a second apparatus having the other functions. The first and the second apparatuses may be mutually communicably connected with each other with or without the network 102. In such a case, the user group information generated by the grouping section 216 of the second apparatus is output to the first apparatus. The first apparatus generates the vehicle allocation information, and transmits the generated information to the terminal device of the vehicle provider, and the mobile terminal 122 of the user 112 and the like each as the member of the corresponding user group.

In the embodiment, the vehicle share ride support system 100 is configured to transmit the vehicle allocation information to the mobile terminal 122 of the user 112 and the like, the mobile terminal 144 of the vehicle provider 142, and the terminal device 154 of the taxi company 152 and the like, and outputs the vehicle allocation information. However, the configuration is not limited to the one as described above. For example, the vehicle share ride support system 100 may be configured to output only the user group information to the mobile terminal 122 of the user 112 and the like, and the mobile terminal 144 of the provider 142 of the vehicle 140 and the like without transmitting the vehicle allocation information. In this case, the provider 142 of the vehicle 140 and/or the taxi company 152 may access the mobile terminal 122 of the respective user 112 and the like each constituting the user group in accordance with the user group information, and offers the vehicle 140 and the taxi 150 for the share ride vehicle to the respective user groups. For example, the accessing may be easily implemented by allowing the user group information to contain the communication addresses and the phone numbers, for example, of the mobile terminal 122 of the user 112 and the like each constituting the user group.

In the embodiment, the vehicle information acquisition section 218 of the vehicle share ride support system 100 is constituted to acquire the vehicle information passively from the mobile terminal 144 of the provider 142 of the vehicle 140 for share ride, and the terminal device 154 of the taxi company 152. However, it is not limited to the one constituted as described above. For example, the vehicle information acquisition section 218 may be constituted to positively acquire the vehicle information by inquiring about existence of the vehicle that can be provided for share ride to the mobile terminal and the terminal device of the provider or the provider company of the share ride vehicle or the shared vehicle at the location near the planned alighting place.

As described above, the vehicle share ride support system 100 according to the embodiment includes the user information acquisition section 210 that acquires the user moving information on the boarding operating vehicle of public transportation to be used by the user 112 and the like (for example, the train 132), the planned alighting place (for example, the departure/arrival place 134), and the destination of the user 112 and the like (for example, the destination 136 and the like). The vehicle share ride support system 100 includes the operation information acquisition section 212 that acquires the operation information on the arrival time of the boarding operating vehicle at the planned alighting place. The vehicle share ride support system 100 includes the arrival time estimation section that estimates the arrival time of the user 112 and the like at the planned alighting place based on the user moving information and the operation information. The vehicle share ride support system 100 includes the grouping section 216 that generates and outputs, based on the user moving information and the estimated arrival time, the user group information indicating the users of the group by the destination, who are assumed to arrive at the planned alighting place within the predetermined time period including the estimated arrival time.

The vehicle share ride support system 100 may be configured to output the user group information of the users of the group by the destination, who board the same operating vehicle of the public transportation to arrive at the same departure/arrival place. Accordingly, the share ride vehicles are simply allocated to the respective user groups in accordance with the user group information. This makes it possible to improve convenience of the users by reducing the waiting time for transfer to the share ride vehicle to be used by the users after alighting from the public transportation without involving the boarding reservation of the public transportation.

The user information acquisition section 210 of the vehicle share ride support system 100 acquires the current location of the user from the mobile terminal 122 of the user 112 and the like, and estimates the boarding operating vehicle of the user based on the acquired current location. The above-described configuration allows reduction in the input load of the user moving information to the mobile terminal 122 of the user 112 and the like.

The user information acquisition section 210 of the vehicle share ride support system 100 estimates the commuting route information of the user 112 and the like, and estimates the user's boarding operating vehicle, planned alighting place, and/or destination based on the commuting route information. The configuration further reduces the input load of the user moving information to the mobile terminal 122 of the user 112 and the like.

The grouping section 216 of the vehicle share ride support system 100 generates the user group information on the grouped users who board the same operating vehicle to arrive at the planned alighting place, and outputs the generated user group information. The configuration allows further improvement in the user's convenience by minimizing the waiting time for transfer to the share ride vehicle to be used by the user after alighting from the public transportation without involving the boarding reservation thereof.

In the vehicle share ride support system 100, the operation information contains the delay information of the boarding operating vehicle of the user 112 and the like. The arrival time estimation section 214 acquires the delay information from the server managed in the public transportation, or the mobile terminal of the information provider. The configuration allows acquisition of highly accurate estimated arrival time based on the latest and large-sized delay information.

When the operation information has been changed, the arrival time estimation section 214 of the vehicle share ride support system 100 re-estimates the arrival time. When the arrival time is re-estimated, the grouping section 216 re-generates the user group information based on the re-estimated arrival time, and outputs the re-generated user group information. The configuration allows user groups once generated to be re-generated based on the latest operating information. This makes it possible to generate efficient user groups adapted to the certain circumstances.

The vehicle share ride support system 100 includes the vehicle information acquisition section 218 that acquires the vehicle information on the vehicle available for share ride with the users (for example, the vehicle 140, the taxi 150). The vehicle share ride support system 100 further includes the vehicle allocation section 220 that allocates the available vehicle to the user group indicated by the user group information based on the vehicle information. The configuration allows quick allocation of the share ride vehicle to the user 112 and the like based on the user group information.

When the user group information is re-generated, the vehicle allocation section 220 of the vehicle share ride support system 100 updates the vehicle allocation. The configuration allows further efficient vehicle allocation adapted to the certain circumstances by re-grouping the allocated vehicles based on the latest operating information.

In the vehicle share ride support system 100, the vehicle corresponds to the shared vehicle to be shared with the users, the share ride vehicle intended to be permitted by the owner of the vehicle for share ride, and the taxi that allows the preliminarily assigned driver to transport the users in response to the request. With the configuration, the use of various types of vehicles that allow share ride may effectively reduce the waiting time for transfer to the share ride vehicle after alighting from the public transportation, resulting in improved user's convenience.

In the vehicle share ride support system 100, the public transportation may be the train, the bus, or the airplane. The configuration allows improvement in the convenience of the user who boards the major public transportation by reducing the waiting time for transfer to the share ride vehicle to be used by the user after alighting from the public transportation without involving the boarding reservation thereof.

### REFERENCE SIGNS LIST

100 vehicle share ride support system
102 network
112, 114, 116, 118 user
122, 124, 126, 128, 144 mobile terminal
130 line
132 train
134 departure/arrival place
136, 138 destination
140 vehicle
142 provider
150 taxi
152 taxi company
154 terminal device
160 transportation server
200 processor
202 storage device
204 communication device
210 user information acquisition section
212 operation information acquisition section
214 arrival time estimation section
216 grouping section
218 vehicle information acquisition section
220 vehicle allocation section
300 title
302 date input box
304, 306, 308 transportation selection button
310 boarding route list
312 planned alighting place list
314 boarding operating vehicle list
316 destination input box
318 map display button
320 enter button
322 automatic input button

What is claimed is:

1. A vehicle share ride support system comprising:
a user information acquisition section that acquires user moving information on an operating vehicle of a public transportation to be used by a user, a planned alighting departure/arrival place, and a destination of the user;
an operation information acquisition section that acquires operation information on an arrival time of the operating vehicle at the planned alighting departure/arrival place;
an arrival time estimation section that estimates the arrival time of the user at the planned alighting departure/arrival place based on the user moving information and the operation information; and
a grouping section that generates and outputs, based on the user moving information and the estimated arrival time, user group information indicating a user group by the destination, including the users who are estimated to arrive at the planned alighting departure/arrival place within a predetermined time period including the estimated arrival time.

2. The vehicle share ride support system according to claim 1, wherein the user information acquisition section acquires a current location of the user from a mobile terminal of the user, and estimates the operating vehicle to be used by the user based on the acquired current location.

3. The vehicle share ride support system according to claim 1, wherein the user information acquisition section acquires commuting route information of the user, and estimates the operating vehicle to be used by the user, the planned alighting departure/arrival place, and/or the destination based on the commuting route information.

4. The vehicle share ride support system according to claim 1, wherein the grouping section generates and outputs the user group information of the group of the users who arrive at the planned alighting departure/arrival place by using the operating vehicle.

5. The vehicle share ride support system according to claim 1, wherein:
the operation information contains delay information of the operating vehicle; and
the arrival time estimation section acquires the delay information from a server managed in the public transportation or a mobile terminal of an information provider.

6. The vehicle share ride support system according to claim 1, wherein:
the arrival time estimation section re-estimates the arrival time when the operation information has been changed; and
when the arrival time is re-estimated, the grouping section re-generates and outputs the user group information based on the re-estimated arrival time.

7. The vehicle share ride support system according to claim 1, further comprising:
a vehicle information acquisition section that acquires vehicle information on the vehicle available for share ride with the users; and
a vehicle allocation section that allocates the available vehicle to the user group indicated by the user group information based on the vehicle information.

8. The vehicle share ride support system according to claim 7, wherein the vehicle allocation section updates the vehicle allocation when the user group information is re-generated.

9. The vehicle share ride support system according to claim 7, wherein the vehicle corresponds to a shared vehicle to be shared with the users, a share ride vehicle intended to be permitted for share ride by an owner of the vehicle, or a taxi that allows a preliminarily assigned driver to transport the user upon request.

10. The vehicle share ride support system according to claim 1, wherein the public transportation includes a railroad, a bus, or an airplane.
